(19) United States
(12) Patent Application Publication
(10) Pub. No.: US 2010/0297891 A1
(43) Pub. Date: Nov. 25, 2010

(54) CONNECTOR FOR HIGH ELECTRICAL POWER APPLICATIONS

(75) Inventors: Klaus Rabbe, Hoexter (DE); Christian Neese, Bielefeld (DE); Martin Drewes, Paderborn (DE); Reiner Tepe, Detmold (DE)

Correspondence Address: LAUBSCHER & LAUBSCHER, P.C., 1160 SPA ROAD, SUITE 2B, ANNAPOLIS, MD, 21403, US

(73) Assignee: WEIDMUELLER INTERFACE GMBH & CO. KG, Detmold (DE)

(21) Appl. No.: 12/777,980

(22) Filed: May 11, 2010

(30) Foreign Application Priority Data
May 22, 2009 (DE) 20 2009 007 276.2

(51) Int. Cl. H01R 13/10

(52) U.S. Cl. 439/682

(57) ABSTRACT

A connector assembly includes a preassembly frame to which the ends of a number of high-voltage transmission lines are connected, whereupon the preassembly frame is mounted in an open-ended chamber contained in a connector housing. The frame includes a first end wall having openings that receive intermediate portions of the transmission lines, which first end wall carries a grounding plate having projections for engaging exposed portions of braided shielding layers of the transmission lines. The free ends of the transmission lines are provided with contact members that are supported by insulation sleeves in wall openings contained in a second end wall of the preassembly frame. A coding arrangement prevents the connector assembly from being connected to an unauthorized companion electrical device.

### BACKGROUND OF THE INVENTION

1. Field of the Invention

A connector assembly includes a preassembly frame to which the ends of a number of high-voltage transmission lines are connected, whereupon the preassembly frame is mounted in an open-ended chamber contained in a connector housing. The frame includes a first end wall having openings that receive intermediate portions of the transmission lines, which first end wall carries a grounding plate having projections for engaging exposed portions of braided shielding layers of the transmission lines. The free ends of the transmission lines are provided with contact members that are supported by insulation sleeves in wall openings contained in a second end wall of the preassembly frame. A coding arrangement prevents the connector assembly from being connected to an unauthorized companion electrical device.

2. Description of Related Art

To transmit high-voltage power outputs, it is necessary so to design connector arrangements that one can make sure, with maximum probability, that the assembly of the housing will not cause the contacts to be bent, twisted or shifted, or perhaps even separated. Besides, the contacting of any possible sheaths of the conductors is a problem that so far has been solved only inadequately.

Against this background, it is the object of the present invention to solve the two abovementioned problems in each case independently of each other. According to a preferred embodiment, a connector arrangement is also to be created where the two mentioned problems are solved together.

### SUMMARY OF THE INVENTION

Accordingly, a primary object of the invention is to provide a connector arrangement including a rigid preassembly frame to which the ends of a plurality of insulated and shielded transmission lines are connected, which frame is subsequently mounted in a protective outer housing. Prior to assembly in the housing, exposed portions of the braided electrically conductive shielding layers of the transmission lines are connected with a grounding plate fastened to a first end wall of the preassembly frame. The free ends of the transmission lines are supported in openings contained in the second end wall of the preassembly frame by cylindrical contact members crimped or otherwise fastened to the bare ends of the transmission line core conductors, and by tubular insulation sleeves arranged concentrically about the contact members.

According to a more specific object of the invention, coding means are provided for preventing connection of the connector arrangement to an unauthorized electrical device, such as a companion connector arrangement.

According to another object of the invention, the connector arrangement is characterized by the provision of a rigid frame on which the conductors and the contacts can be preassembled and which can be placed in the protective housing in the preassembled state. The frame first of all constitutes a stable assembly space or limits such a space in which the conductors and the contacts can be connected with each other. Optionally, a ground plate is also placed in the frame in a conducting manner for engagement with the braided shielding layers of the transmission lines. Only then is the unit, thus preassembled, inserted in the housing, or only then is the housing preferably pushed up upon the frame. The frame prevents the elements that are preassembled in or around the frame from being jiggled or damaged during the assembly of the housing.

In particular, the free ends of the transmission line core leads of the transmission lines are connected with the frame by means of contact members fastened to the core conductor bare ends, respectively. Optionally, moreover, the shielding layer contacting device for contacting of one or more transmission line sheaths is arranged in the frame.

Here it is practical when the housing is a circumferentially enclosed casing with a preferably rectangular cross-section. This casing is furthermore preferably laterally open at its two axial ends and can be pushed upon the frame.

In a preferred variant, the frame has two base plates that are aligned parallel to each other and that are connected with each other by means of studs in the area of their corners. This frame is designed to be stable and can be put together with simple means during the assembly of the patch plug.

With regard to the sheath-contacting device, it is provided that the latter preferably have contact projections that engage on the outside against the shielding sheath layer, whereby the conductors and the contact projections bridges are bordered by attachment means such as preferably metallic screw-operated hose clamps or metal cable clamps with which the contact projections are pressed against the braided sheaths of the transmission lines. At this point, it is furthermore particularly advantageous when the sheath-contacting device has a ground plate with integral contact projections.

The sheath-contacting device makes it possible in a simple manner to contact the braided conductive sheath layer securely and quickly, specifically in such a way that the conducting connection will also be suitable for the temporary shunting of higher outputs.

### BRIEF DESCRIPTION OF THE DRAWINGS

Other objects and advantages of the invention will become apparent from a study of the following specification, when viewed in the light of the accompanying drawing, in which:

FIG. 1 is a perspective view of a connector assembly for high voltage transmission lines;

FIG. 2 is a perspective view of the contact members fastened to the bare ends of the transmission lines of FIG. 1;

FIG. 3 is a perspective view of the inner side of a first end wall of the preassembly frame;

FIG. 4 is a perspective view of the inner side of a second end wall of the preassemble frame;

FIG. 5 is an outer rear perspective view of the assembled preassembly frame;

FIG. 6 is a outer front perspective view of the assembled preassembly frame;

FIG. 7 is a perspective side view of the assembled preassembly frame with certain parts broken away;

FIG. 8 is a front perspective view of the assembled preassembly frame;

FIG. 9a is an exploded front view of the front end portion of a first connector arrangement, FIG. 9b is a front view of the apparatus of FIG. 9a in an assembled condition, and FIG. 9c is a detailed view of a portion of the apparatus of FIG. 9b, and

FIGS. 10a, 10b, and 10c are corresponding views of a companion second connector arrangement;

FIGS. 11 and 12 are front perspective views of male and female contact members,

FIG. 13 is a front perspective view of one of the connector housings of FIG. 1; and

FIG. 14 is a rear perspective view of one of the assembled connectors of FIG. 1.

### DETAILED DESCRIPTION OF THE INVENTION

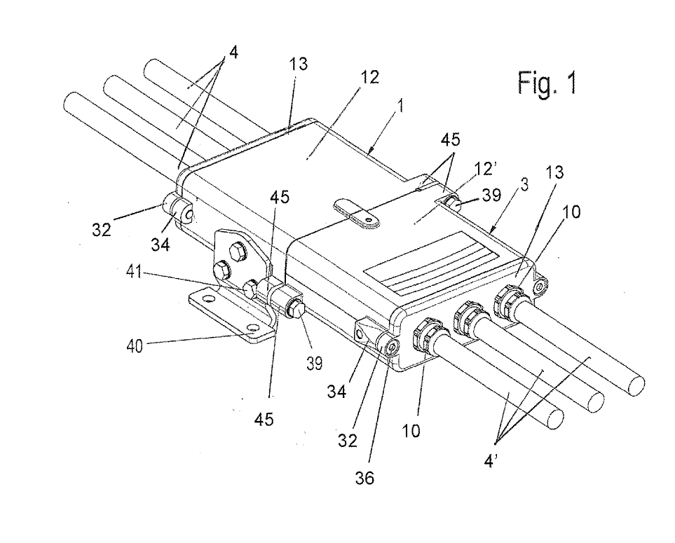

Referring first more particularly to FIG. 1, the connector arrangement includes a pair of electrical connectors 1 and 3 including housings 12 and 13 that are fastened together by integral ear portions 45, and connecting bolts 39 that extend through aligned threaded bores contained in the housing ear portions. The housing assembly is fastened to a fixed support by L-shaped foot means 40 that are bolted to opposite sides of the assembly by bolts 41. A plurality of high-voltage high-power insulated and shielded transmission lines 4 and 4′ are connected adjacent their free ends by threaded fastening nuts 10 with preassembly frame end walls 13 at each end of the assembly, as will be described in greater detail below.

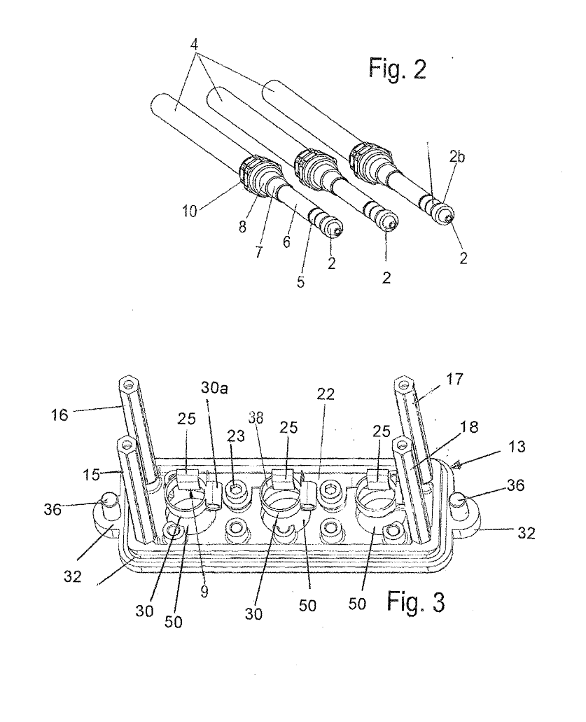

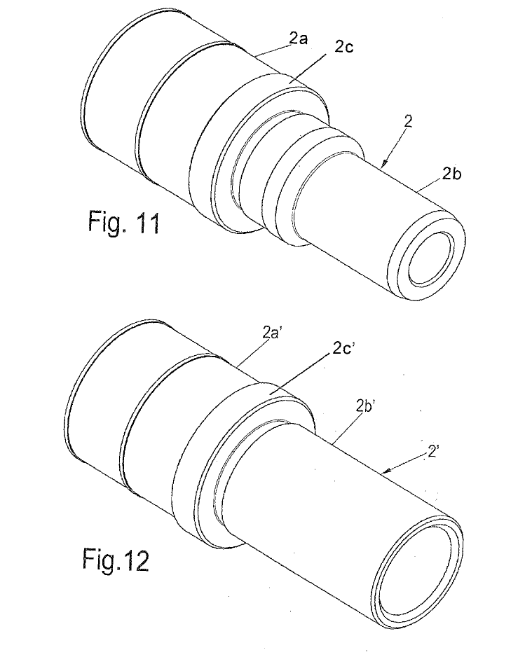

Referring to FIG. 2, it will be seen that each of the insulated transmission lines 4 includes a core conductor 5 concentrically surrounded by a first layer of insulation material 6, a braided conductive metal shielding layer 7, and an outer insulation layer 8. Mounted on the stripped bare ends of the core conductors 5 are a plurality of cylindrical contact members 2 having tubular first ends 2a that are crimped or soldered to the bare core conductors, respectively. As best shown in FIG. 11, the contact members 2 comprise male contacts having at their other ends male contact portions 2b, and an intermediate portion 2c. In the modification of FIG. 12, the contact members 2′ are female contact members having a tubular crimping end 2a′, a female contact end 2b′, and an intermediate portion 2c′.

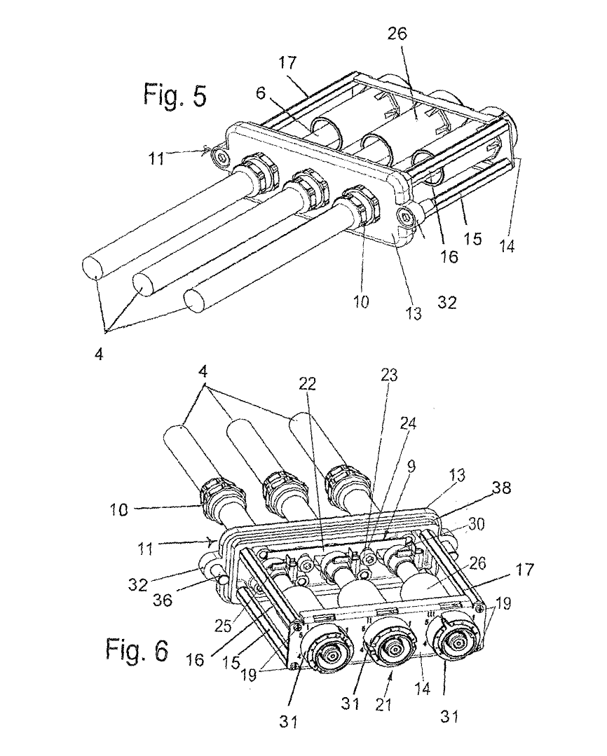

As shown in FIGS. 5-7, the transmission line free ends extend longitudinally into a rigid rectangular preassembly frame 11 via openings contained in a rectangular vertical first frame end wall 13, which is preferably formed from a suitable electrically insulating synthetic plastic material. Connected with the first end wall 13 by a plurality of longitudinal studs and associated screws 19 is a second end wall 14. which is preferably formed of sheet metal.

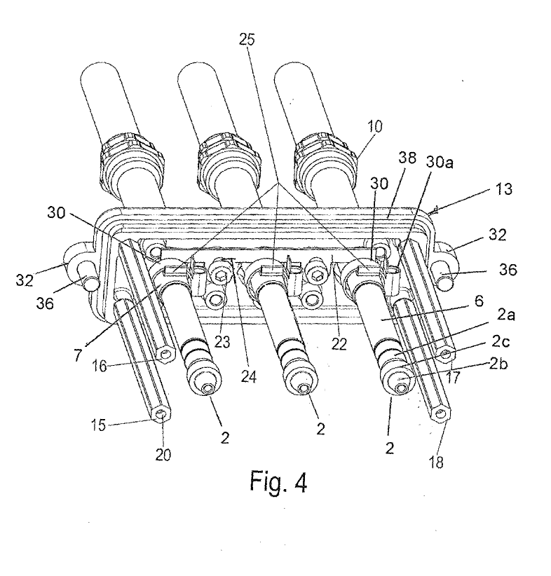

As is shown in FIGS. 3 and 4, the frame studs 15-18 are integral with and extend from the inner surface of the first end wall 13 adjacent the corners thereof. Mounted by screws 23 on the inner face of the first frame end wall 13 adjacent the circular wall openings 50 is a conductive grounding plate 22 that is adapted for connection with ground. The screws 23 extend through corresponding oversized openings 24 contained in the grounding plate, thereby to permit adjustment of the plate relative to the wall openings 50. The grounding plate 22 is provided with integral projections 25 that are arranged for engagement with the exposed portions of the braided shielding layers 7 of the transmission lines 4, respectively. Hose-type clamping devices operated by conventional screw-operating means 30a are connected with the grounding plate for clamping the exposed braided shielding portions 7 of the transmission lines in firm electrical engagement with the grounding plate projections 25. The end wall 13 is provided with a pair of integral ear portion 32 containing threaded bores in which are provided fastening screws 36 for connecting the preassembly frame with the associate housing, as will be described in greater detail below. Also, the inner surface of the end wall is provided with a continuous step or ridge portion 38 (FIGS. 3, 4 and 8) that is adapted to support a compressible sealing gasket (not shown).

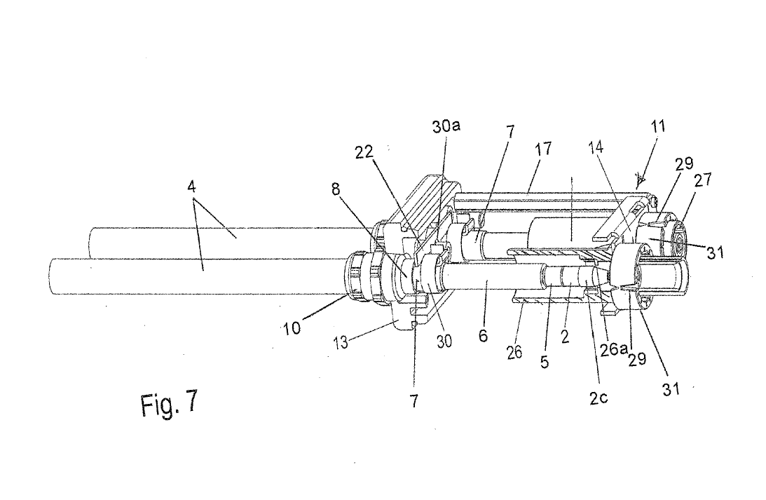

Referring now to FIGS. 6-8, the front end wall 14 of the preassembly frame 11 contains non-circular wall openings for receiving generally tubular insulation sleeves 26, respectively. Preferably these wall openings and the associated outer circumferential surface portions of the insulation sleeves 26 have a hexagonal cross-sectional configuration. At their one ends, the insulation sleeves extend though the openings and are connected with the front wall 14 by annular split locking devices 31, respectively. As best shown in FIG. 7, the internal surfaces of the insulation sleeves are provided with annular support ribs 26a that support the intermediate portions 2c of the contact members 2, respectively.

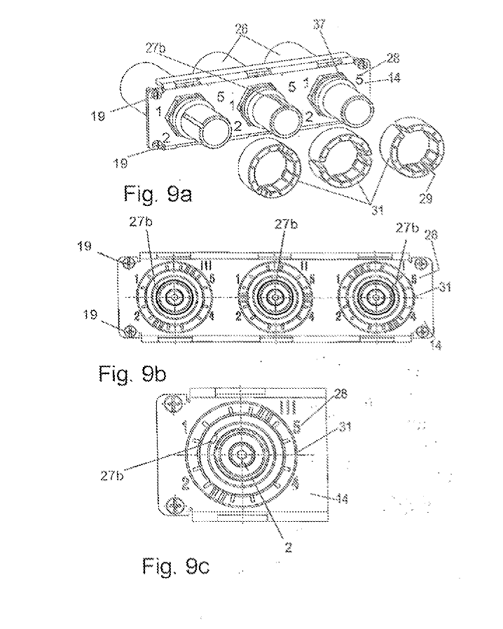

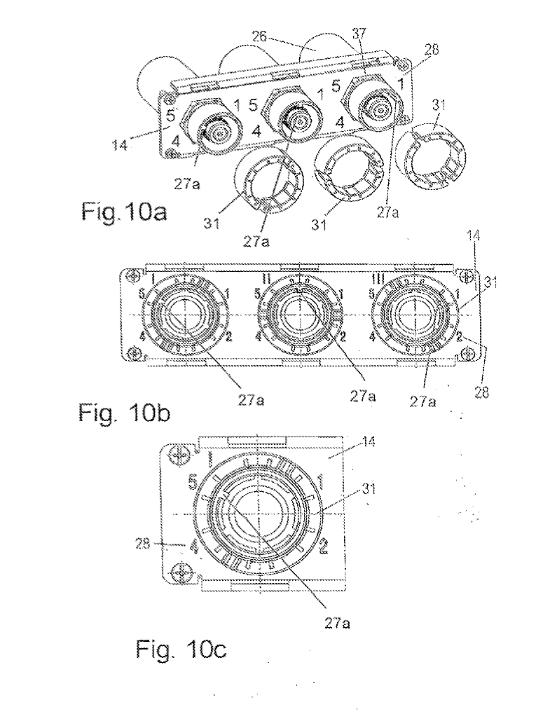

According to an important feature of the invention, coding means are provided for preventing the connection of the connector assembly with an unauthorized second connector or other electrical device. To this end, the external surfaces of the protruding portions of the insulating sleeves 26 of FIGS. 9a-9c are provided with longitudinal slots 27b, respectively. The angular positions of these slots relative to the second end wall 14 may be controlled as a consequence of the cooperation between the hexagonal outer circumferential surface of the insulation sleeves 26 and the correspond hexagonal configurations of the corresponding wall openings. In other words, the insulation sleeves may be rotated about their longitudinal axes to any one of six positions relative to the second end wall 14, as indicated by the markings 28 on the external surface of the end wall 14. Similarly, the internal surfaces of the oversized extending end portions of the insulation sleeves of the corresponding authorized connector arrangement of FIGS. 10a-10c are provided with longitudinal projection ribs 27a which are adapted to extend within the slots 27a of the authorized companion connector arrangement when the insulation sleeves 26 of FIGS. 10a-10c have the same angular arrangement as the insulation sleeves of FIGS. 9a-9c, as indicated by the markings 28.

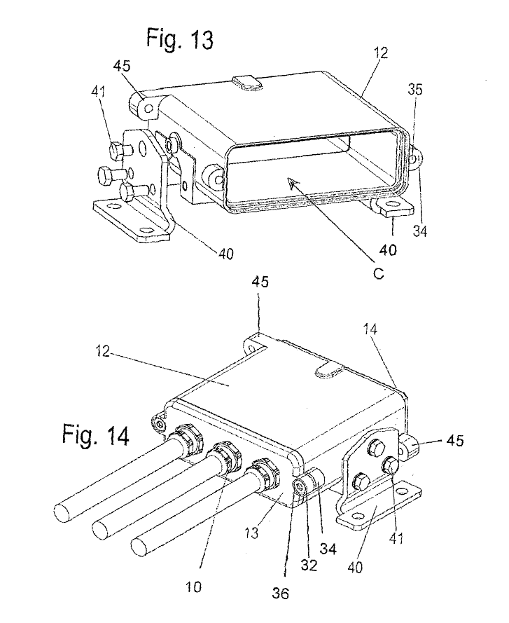

Following the complete assembly of the components on the preassembly frame 11, the frame is inserted longitudinally into the connector housing 12 of FIG. 13, and is locked into place by the cooperation between screws 36 and the threaded bores of the ear portions 34 and 36 of the housing and the first end wall 13. The housing 12 may be connected with a fixed support by means of the L-shaped mounting feet 40. As shown in FIG. 1, an authorized correspondingly-coded companion connector assembly 3 may then be fastened to the connector assembly of FIG. 14 by the connecting bolt and ear connecting means 39 and 45.

By way of example, while three transmission lines 4 have been shown to be connected to the connector 1, the number of transmission lines 4 should be considered as purely exemplary. Transmission lines 4 preferably are those with single-core lead or multi-core lead transmission-line core leads 5 with a relatively large cross-section that are suitable for the transmission of high power outputs such as they are needed, for example, to supply electric motors for the purpose of driving rail vehicles (for example, more than 500 A current intensity and more than 1 kV voltage).

The layers surrounding the transmission line core lead 5 are staggered or stripped to be remote from the end of conductor 4 in various axial lengths so that it is possible to provide the transmission line core lead 5 with the contact casing 2 and to abut the sheath 7 thereof in an electrically conducting manner separately against a shield-contacting device 9 of the connector 1 (see FIGS. 3 and 4).

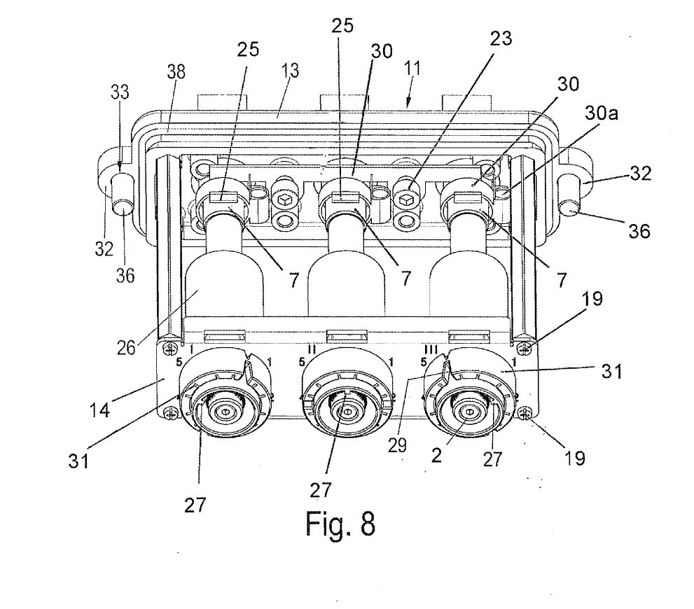

Because of the high outputs to be transmitted, it is necessary to design the connector 1 such that mistakes can be ruled out as much as possible during its assembly. Furthermore, braided shield layer 7 preferably is to be so contacted that it will, on the one hand, be contactable in a simple manner, but, on the other hand, it will also be suitable for the shunting of higher outputs, at any rate, for a predefined span of time. Thus, the connector 1 has a frame 11 (FIG. 8),which is so designed that, upon it, transmission line 4 as well as the cable shielding layer are first assembled or contacted in a conclusive manner before a housing 12 is assembled upon frame 11. In this way, it is possible first of all to create a preassembled unit whose configuration is error free. That can also be checked out easily by visual means. Only then is housing 12 assembled. In this way, it is possible in a particularly simple manner to contact the shield layers 7 of the transmission lines 4 in a secure and simple fashion. In this way, one can make sure that the connectors 1 and 3 cannot be stuck together in a twisted position. The corresponding patch plug is fashioned like the previously described patch plug except for the contact casings 2′ (FIG. 12) and the corresponding coding means (FIG. 11) (preferably extensively or precisely).

First of all, frame 11 is preassembled with the parts shown in FIG. 8. Only then is housing 12 in this case pushed on from the side of plate 14 (FIGS. 13, 14). Preferably, plate 13 is so dimensioned that the circulating edge of housing 12 will rest on a step 38 when it is in the assembled state, possibly provided with a continuous seal (not shown in FIG. 8). Here, housing 12 and plate 13 in each case are screwed together with each other on corresponding screw connection means such as ridges 32 with boreholes 33 and screws 36, something that connects the entire frame 11 in a stable manner with the two plates 13, 14 and the housing 12. The stable frame 11 makes sure that, as housing 12 is shoved upon frame 11, the parts on the inside of frame 11 cannot be shifted around or cannot be damaged. The housing preferably extends from plate 13 all the way to plate 14 on the plug-in front which, along its outer circumference, is bordered by the housing. Shoulders 34 with boreholes 35 can be provided on housing 13 in order to screw together the two connector assemblies in the completely assembled state using corresponding screws 39 (FIG. 1). An assembly foot 40, which can be bolted upon the housing with screws 41 is used to fix the connector assembly on a foundation base.

While in accordance with the provisions of the Patent Statutes the preferred forms and embodiments of the invention have been illustrated and described, it will be apparent to those skilled in the art that changes may be made without deviating from the invention described above.

What is claimed is:

1. An electrical connector for connecting the ends of a plurality of insulated high-voltage transmission lines (4) with an electrical device, comprising:
(a) a housing (12; 12′) containing a longitudinally-extending open-ended chamber (C);
(b) a rigid preassembly frame (11) including:
(1) a pair of parallel spaced vertical end walls (13, 14); and
(2) a plurality of parallel horizontal longitudinally-extending studs (15-18) connected between said end walls;
(c) first transmission line mounting means (10) for mounting intermediate portions of the insulated transmission lines in openings contained in a first one (13) of said end walls, respectively;
(d) second transmission line mounting means (2, 26, 31) for mounting the free ends of the insulated transmission lines in openings contained in the second one (14) of said end walls, respectively; and
(e) frame mounting means (32, 34, 36) for mounting said preassembly frame longitudinally in said housing chamber.

2. An electrical connector as defined in claim 1, wherein said preassembly frame end walls have a generally-rectangular configuration; and further wherein said housing chamber has a corresponding generally rectangular cross-sectional configuration.

3. An electrical connector as defined in claim 1, wherein each of the insulated transmission lines includes a core conductor (5), a first layer (6) of insulating material arranged concentrically about the core conductor, a braided conductive shield layer (7) arranged concentrically about the first insulation layer, and an outer layer (8) of insulating material arranged concentrically about the braided shield layer; and further including:
(f) grounding means (22) mounted on said first end wall for electrical engagement with exposed portions of the braided shield layers of the transmission lines at locations at which the outer insulation layer has been removed, thereby to ground the transmission lines.

4. An electrical connector as defined in claim 3, wherein said first end wall is formed from an electrically insulating synthetic plastic material; and further wherein said grounding means comprises:
(1) a vertical conductive grounding plate (22) adapted for connection with ground;
(2) grounding plate connecting means (23) connecting said grounding plate to one of the side surfaces of said first end wall; and
(3) a plurality of integral shield contact projections (25) extending from said grounding plate for electrical engagement with the exposed braided layer portions of the transmission lines.

5. An electrical connector as defined in claim 4, wherein said first transmission line mounting means includes clamping means (30) for clamping each of the transmission lines to said grounding plate.

6. An electrical connector as defined in claim 1, wherein said second transmission line mounting means comprises:
(1) a plurality of generally-cylindrical electrical contact members (2; 2′) having tubular first end portions (2a, 2a′) fastened to bare ends of the transmission line core conductors, respectively, said contact members having second end portions (2b, 2b′) adjacent said second end wall openings, respectively, and intermediate portions (2c, 2c′) arranged between said first and second end portions;
(2) a plurality of tubular insulation sleeves (26) arranged concentrically about said contact members, respectively, each of said insulation sleeves having an outer circumferential surface in engagement with the associated wall openings, respectively, and an internal annular surface (26a) in engagement with the associated contact member intermediate portion; and
(3) a plurality of fastening means (31) for fastening said insulation sleeves to said second end wall, respectively.

7. An electrical connector as defined in claim 6, wherein said contact member first ends are fastened by crimping to the corresponding core conductor bare ends, respectively.

8. An electrical connector as defined in claim 6, wherein said contact member second end is a male contact (2b).

9. An electrical connector as defined in claim 6, wherein said contact member second end is a female contact (2b′).

10. An electrical connector as defined in claim 6, wherein each of said insulation sleeves extends at one end through the associated second end wall opening; and
further wherein said fastening means comprises an annular split locking device (31) mounted on each of said insulation sleeve extending one ends.

11. An electrical connector as defined in claim 6, and further including coding means (27a, 27b) for preventing the electrical connector from being connected to an unauthorized electrical device.

12. An electrical connector as defined in claim 11, wherein at least a portion of the external surface of said insulation sleeve and the associated wall opening have corresponding non-circular cross-sectional configurations.

13. An electrical connector as defined in claim 12, wherein the cross-sectional configurations of the external surface of said insulation sleeves and said wall openings are hexagonal, whereby each of said insulation sleeves may be caused to have a predetermined angular position about its longitudinal axis relative to said second end wall.

14. An electrical connector as defined in claim 13, wherein the insulation sleeves of one of said connector and said electrical device are provided with internal longitudinal coding projections (27a), and the insulation sleeves of the other of said connector and electrical device are provided with external longitudinal coding slots (27b).

15. An electrical connector as defined in claim 13, wherein the external surface of said second end wall (14) is provided with visual markings (28) which indicate the angular relationship of each of said insulation sleeves about its longitudinal axis relative to said second end wall.

16. An electrical connector as defined in claim 11, wherein said electrical device comprises a companion second electrical connector; and further including:
(f) housing connecting means (39, 45) for connecting together the housings of said connectors.
